(19) United States
(12) Patent Application Publication
(10) Pub. No.: US 2015/0283643 A1
(43) Pub. Date: Oct. 8, 2015

(54) Method and Component

(71) Applicants: Patrik Dahlman, Shanghai (CN); Viktor Recina, Torslanda (SE); Staffan Larsson, Goteborg (SE)

(72) Inventors: Patrik Dahlman, Shanghai (CN); Viktor Recina, Torslanda (SE); Staffan Larsson, Goteborg (SE)

(21) Appl. No.: 14/367,879

(22) PCT Filed: Nov. 26, 2012
(86) PCT No.: PCT/SE2012/000193

§ 371 Date: Jun. 20, 2014

(30) Foreign Application Priority Data
Dec. 20, 2011 (SE) 1100938-8

(51) Int. Cl. B23K 11/04; C21D 9/40; C22C 38/48; C22C 38/46; C22C 38/44; F16C 33/64; C22C 38/06; C22C 38/04; C22C 38/02; C22C 38/00; F16C 33/62; B23K 11/36; C22C 38/42

(52) U.S. Cl. CPC B23K 11/04; B23K 11/36; C21D 9/40; C22C 38/48; C22C 38/46; C22C 38/44; C22C 38/42; C22C 38/06; C22C 38/04; C22C 38/02; C22C 38/002; F16C 33/62; F16C 33/64

(57) ABSTRACT

A method for manufacturing a steel component having a flash butt welded joint. The method comprises a step of flash butt welding the weld joint by flashing and upsetting the weld and a step of supplying heat to at least the weld joint of said component after the step of upsetting the weld to increase the temperature of the weld joint, or to maintain the temperature of the weld joint at an elevated temperature.

### CROSS REFERENCE TO RELATED APPLICATIONS

This is a National Stage application claiming the benefit of International Application Number PCT/SE2012/000193 filed on 26 Nov. 2012, which claims the benefit of Sweden Patent Application Number SE20110000938 filed on 20 Dec. 2011, both of which are incorporated herein by reference in their entireties.

### TECHNICAL FIELD

The present invention concerns a method for manufacturing a component, such as a bearing ring, from steel. The present invention also concerns a component manufactured using such a method.

### BACKGROUND OF THE INVENTION

Flash-butt welding, or “flash welding” is a resistance welding technique for joining segments of metal rail, rod, chain or pipe in which the segments are aligned end to end and electronically charged, producing an electric arc that melts and welds the ends of the segments, yielding an exceptionally strong and smooth joint.

A flash butt welding circuit usually consists of a low-voltage, high-current energy source (usually a welding transformer) and two clamping electrodes. The two segments that are to be welded are clamped in the electrodes and brought together until they meet, making light contact. Energizing the transformer causes a high-density current to flow through the areas that are in contact with each other. Flashing starts, and the segments are forged together with sufficient force and speed to maintain a flashing action. After a heat gradient has been established on the two surfaces to be welded, an upset force is applied to complete the weld. This upset force extrudes slag, oxides and molten metal from the weld zone, leaving a welding accretion in the colder zone of the heated metal. The joint is then allowed to cool slightly before the clamps are opened to release the welded article. The welding accretion may be left in place or removed by shearing while the welded article is still hot, or by grinding, depending on the requirements.

Although flash butt welding is a simple and efficient welding technique, the physical properties of a component in the vicinity of its weld joint(s) may be adversely affected by the flash butt welding, because of defects, such as weld/quench cracks, which occur during and after the flash butt welding, and since the microstructure of the steel in a heat affected zone (HAZ) around a weld joint will be modified by the flash butt welding.

### SUMMARY OF THE INVENTION

An object of the invention is to provide an improved method for manufacturing a steel component having a flash butt weld joint.

This object is achieved by a method comprising the step of flash butt welding the joint by flashing and upsetting the weld, and then supplying heat to at least the weld joint of the component after the step of upsetting the weld to increase the temperature of the weld joint, or to maintain the temperature of the weld joint at an elevated temperature.

By supplying heat to at least the weld joint of a component after the step of upsetting the weld, defects such as weld/quench cracks may be avoided or reduced. Furthermore, the microstructure in a heat affected zone (HAZ) around the weld joint may be at least partly restored to the pre-flash butt welding microstructure so that there is no softened zone around the weld joint in the manufactured component. The course bainite structure normally observed in a heat affected zone (HAZ) after flash butt welding may namely be at least party transformed by supplying heat to at least the weld joint after flash butt welding, whereby the hardness/toughness of the steel in the HAZ will be at least partly restored or modified to substantially match the hardness/toughness of the steel in the remainder of the steel, which was not adversely affected by heat from the flash butt welding process.

Heat may be supplied only in the vicinity of the weld joint, or to one or more parts of the component, whereupon heat may be transferred to the weld joint, by conduction through the component itself for example. Heat is namely supplied at least to the steel that has been adversely affected by the flash butt welding, i.e. steel in the heat affected zone (HAZ) around the, or each weld joint of a component.

According to an embodiment of the invention the method comprises the step of cooling the component to a temperature above the martensite start temperature (Ms) in order to form pearlite/bainite before the step of supplying heat to at least the weld joint of the component, and after the step of upsetting the weld to increase the temperature of the weld joint of said component.

According to an embodiment of the invention the heat is supplied by heating at least the weld joint with heating means, such as induction heating means.

According to a further embodiment of the invention the heat is supplied by heating at least the weld joint with flash butt welding apparatus. The heat is preferably supplied by heating at least the weld joint with flash butt welding apparatus using alternating current (AC) so that the component may be kept cooler than if direct current (DC) were used.

According to an embodiment of the invention the heat is additionally or alternatively supplied by insulating at least the weld joint after the step of upsetting the weld. Thermally insulating material may be provided at least around the weld joint to prevent, or to slow down the rate of cooling of the component. A sleeve of thermally insulating material may for example be placed around the weld joint after the step of upsetting the weld.

According to another embodiment of the invention, the method comprises the step of cooling the component, to room temperature for example, only after the step of supplying heat to at least the weld joint.

According to a further embodiment of the invention, the method comprises the step of hardening at least part of the component after the heat supplying step. The component may be cooled, to room temperature for example, between the heat supplying step and the hardening step.

According to a further embodiment of the invention the component is a ring, such as a bearing ring. The method according to the present invention is particularly, but not exclusively, suitable for the manufacture of large sized rings (i.e. rings having an outer diameter equal to or greater than 0.5 m, greater than 1 m, greater than 2 m or greater than 3 m).

According to another embodiment of the invention, the steel has a carbon content of 0.1-1.1 weight-%, preferably 0.6-1.1 weight-%, or most preferably 0.8-1.05 weight-%.

According to an embodiment of the invention, the steel has the following composition in weight-%:

C 0.5-1.1

Si 0-0.15

Mn 0-1.0

Cr 0.01-2.0

Mo 0.01-1.0

Ni 0.01-2.0

V and/or Nb 0.01-1.0 of V or 0.01-1.0 of Nb, or 0.01-1.0 of both elements

0-0.002

P 0-0.010

Cu 0-0.15

Al 0.010-1.0

balance Fe and normally occurring impurities.

By minimizing the silicon content, and reducing the manganese and chromium content of the steel (which are alloying elements that are easily oxidised) to the levels indicated above, the steel will be more stable and will not be as easily oxidised during flash butt welding. The sulphur content of the steel is reduced to an absolute minimum, whereby the content of non-desirable non-metallic inclusions in steel that has been subjected to flash butt welding will be minimized. A high level of through-thickness ductility may be obtained by means of a special ladle treatment during steel making which ensures very low sulphur content and a controlled shape of non-metallic inclusions.

The phosphorus content of the steel is also reduced to an absolute minimum in order to hinder residual or tramp elements in the steel migrating to austenite grain boundaries when the steel is subjected to flash butt welding, which would otherwise significantly weaken the weld zone. The addition of molybdenum, nickel and optionally vanadium provides steel with a hardenability sufficient to enable through-hardening of large components (i.e. component having an outer diameter of 500 mm or more).

The adverse effects of the unfavourable material flow that flash butt welding creates may therefore be limited by using such steel. Using such steel namely provides a joined/welded component having a superior joint/weld since the joined/welded component does not contain areas of structural weakness as might otherwise occur. Such a joined/welded component therefore has a high degree of structural integrity compared to joined/welded component that does not comprise such steel. Such steel is therefore suitable for flash butt welding and in particular for the manufacture of components intended for an application with high demands on fatigue and toughness properties, which components are to be subjected to flash butt welding during or after their manufacture.

The present invention also concerns a component that it is manufactured using a method according to any of the embodiments of the invention. The component may be a ring, such as a bearing ring for use in a bearing such as a roller bearing, a needle bearing, a tapered roller bearing, a spherical roller bearing, a toroidal roller bearing, a thrust bearing or a bearing for any application in which is subjected to alternating Hertzian stresses, such as rolling contact or combined rolling and sliding. The bearing may for example be used in automotive, wind, marine, metal producing or other machine applications which require high wear resistance and/or increased fatigue and tensile strength.

### BRIEF DESCRIPTION OF THE DRAWINGS

The present invention will hereinafter be further explained by means of non-limiting examples with reference to the appended schematic figures where;

FIGS. 1-4 show steps of a method according to an embodiment of the invention,

FIG. 5 shows a bearing ring after a flash butt welding step according to an embodiment of the invention,

FIG. 6 shows the steps of a method according to an embodiment of the invention, and

FIG. 7 shows a bearing according to an embodiment of the invention.

It should be noted that the drawings have not been drawn to scale and that the dimensions of certain features have been exaggerated for the sake of clarity.

### DETAILED DESCRIPTION OF EMBODIMENTS

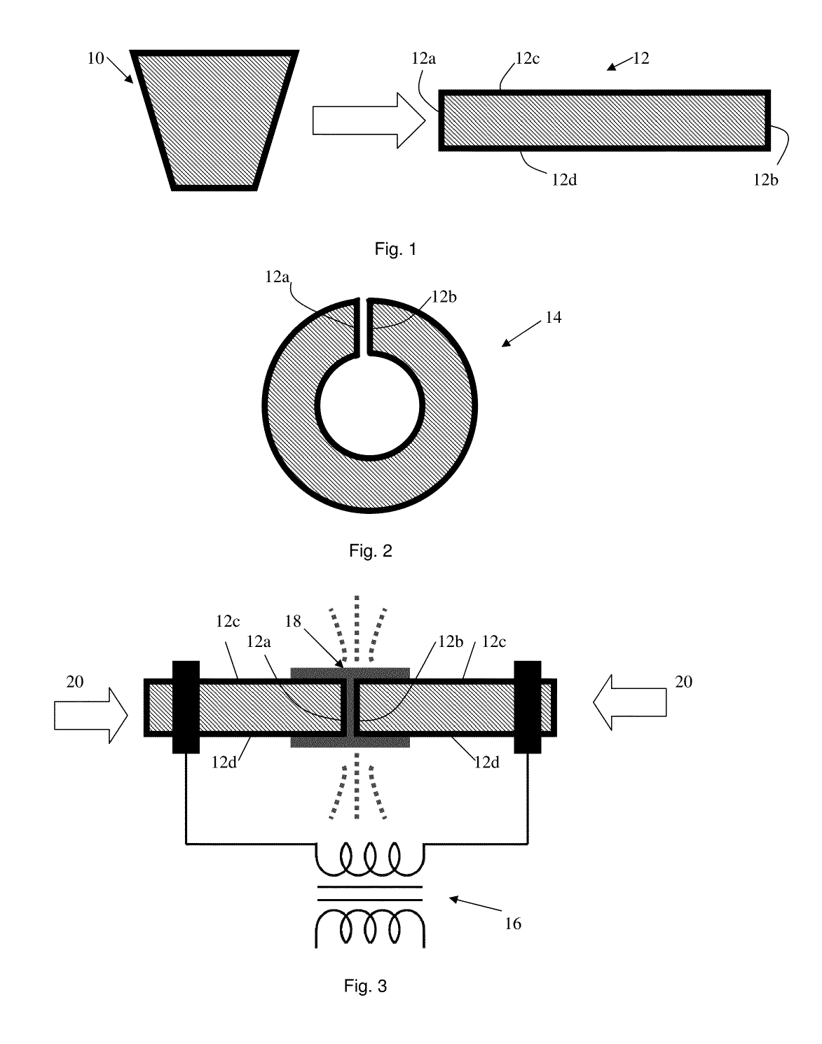

FIGS. 1-4 schematically show various method steps of a method according to an embodiment of the invention. FIG. 1 shows steel 10 that is forged to produce a steel bar 12 having two opposed ends 12a and 12b. A slab, bloom, or billet may be forged from an ingot weighing over 4 ton, over 10 ton, over 15 ton, over 20 ton or more. At least one steel bar may be forged or cut from the slab bloom or billet. A billet is a length of metal that has a round or square cross-section, with an area less than 230 cm2. A bloom is similar to a billet except its cross-sectional area is greater than 230 cm2. A slab is a length of metal that is rectangular in cross-section. The steel may have the following composition in weight-%: C 0.5-1.1, Si 0-0.15, Mn 0-1.0, Cr 0.01-2.0, Mo 0.01-1.0, Ni 0.01-2.0, V and/or Nb; 0.01-1.0 of V or 0.01-1.0 of Nb, or 0.01-1.0 of both elements, S 0-0.002, P 0-0.010, Cu 0-0.15, Al 0.010-1.0 and balance Fe and normally occurring impurities.

It should be noted that the ends 12a, 12b of the steel bar 12 shown in the illustrated embodiment comprise ends that form an angle of 90° to a side surface 12c, 12d of the steel bar 12. A steel bar 12 may however comprise an end 12a, 12b that forms an angle greater or less than 90° to a side surface 12c, 12d of a steel bar, a steel bar 12 may namely comprise diagonally sloping ends. Furthermore, the ends 12a and 12b of the steel bar 12 need not necessarily have a flat surface.

At least one part of at least one surface 12a, 12b, 12c, 12d of the steel bar may be carburized prior to flash butt welding. For example, the opposed ends may be uniformly or non-uniformly carburized to form a continuous or non-continuous carburized layer using any conventional method in which the steel bar is heated in the presence of another material that liberates carbon as it decomposes and then cooled rapidly by quenching.

FIG. 2 shows a single steel bar 12 that has been formed into an open bearing ring 14. It should be noted that each of a plurality of steel bars 12 may alternatively be formed into a ring segment, whereby two or more ring segments may then be flash butt welded together to form a bearing ring 14 comprising two or more weld joints.

FIG. 3 shows the ends 12a, 12b of an open bearing ring 14 being flash butt welded together. The ends 12a, 12b of the open bearing ring 14 are clamped and brought together at a controlled rate and current from a transformer 16 is applied. An arc is created between the two ends 12a, 12b. At the beginning of the flash butt welding process, the arc gap 18 is large enough to even out and clean the two surfaces 12a, 12b. Reducing and then closing and opening the gap 18 creates heat in the two surfaces 12a, 12b. When the temperature at the two surfaces 12a, 12b has reached the forging temperature, pressure is applied in the directions of block arrows 20 in FIG. 3 (or a moveable end is forged against a stationary end). A flash is created between the two surfaces 12a, 12b, which causes any carbon in the welding area to flow radially outwards from the surfaces 12a, 12b towards the inside and outside surfaces 12c, 12d of the bearing ring, resulting in a clean weld joint. After flashing, an upset force is suddenly applied to complete the weld. This upset force extrudes slag, oxides and molten metal from the weld zone leaving a welding accretion in the colder zone of the heated metal.

According to an embodiment of the invention the welded bearing ring is cooled to a temperature above the martensite start temperature (Ms) in order to form pearlite/bainite after the step of upsetting the weld to increase the temperature of the weld joint of said component.

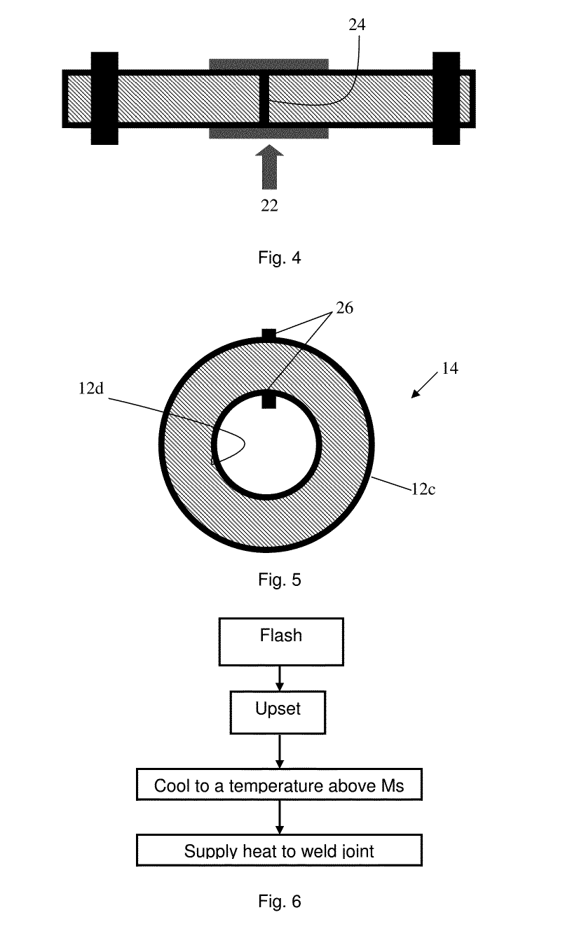

FIG. 4 shows that, after the flashing, upsetting and cooling steps, heat 22 is supplied to the weld joint 24 of the component to increase the temperature of the weld joint 24 or to maintain the temperature of the weld joint 24 at an elevated temperature. The heat 22 may be supplied by any suitable heating means, such as by induction heating means. Additionally, or alternatively, heat 22 may be supplied using the flash butt welding apparatus itself, using alternating current (AC) for example. Alternatively, or additionally the weld joint 24 may be insulated by providing thermally-insulating material at least around the weld joint 24. For example, a sleeve of thermally insulating material may be placed around the weld joint 24. Heat may be supplied to the weld joint 24 so that the temperature of the weld joint is kept at a temperature of about 900° C. for at least 5 minutes.

At least part of the welded component may be subjected to a post-welding heat treatment, such as carburizing, after the heat supplying step in order to increase its surface hardness, wear resistance and/or fatigue and tensile strength. Carburizing is a heat treatment process in which an iron or steel component is heated in the presence of another material that liberates carbon as it decomposes. The outer surface of the component will have a higher carbon content than the original material. When the iron or steel component is cooled rapidly by quenching, the higher carbon content on the outer surface becomes hard, while the core remains soft (i.e. ductile) and tough.

Alternatively, the welded component may be cooled after the heat supplying step, in a water-, oil- or polymer-based quench for example.

Any welding accretion 26, containing slag, oxides and/or molten metal for example, (shown in FIG. 5) which accumulates on the inner and outer surfaces 12d and 12c of the welded bearing ring may be removed by shearing or grinding for example.

FIG. 6 shows the steps of a method for manufacturing a component from steel according to an embodiment of the invention. The method comprises the steps of flash butt welding the component by flashing and upsetting the weld, cooling the component to a temperature above the martensite start temperature (Ms) in order to form pearlite/bainite and then supplying heat to at least a weld joint of the component to increase the temperature of the weld joint, or to maintain the temperature of the weld joint at an elevated temperature. The component is not allowed to cool substantially between the steps of upsetting the weld joint and supplying heat to at least the weld joint of the component, i.e. the component is not cooled to room temperature, for example, before heat is supplied to at least the weld joint. After heat has been supplied to the weld joint for a predetermined amount of time, at least part of the component may be subjected to hardening heat treatment for example.

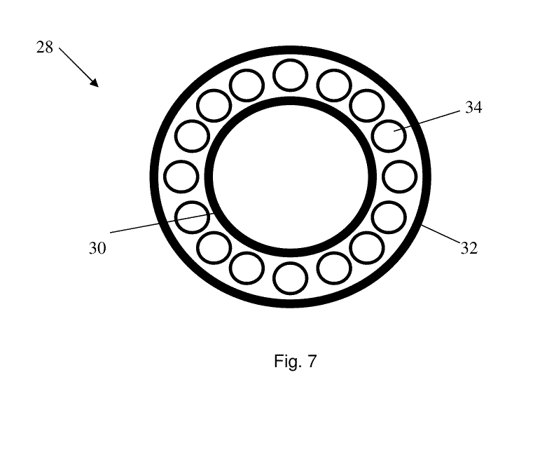

FIG. 7 shows an example of a bearing 28, namely a rolling element bearing that may range in size from 10 mm diameter to a few metres diameter and have a load-carrying capacity from a few tens of grams to many thousands of tonnes. The bearing 28 according to the present invention may namely be of any size and have any load-carrying capacity. The bearing 28 has an inner ring 30 and an outer ring 32, one or both of which may be constituted by a ring according to the present invention, and a set of rolling elements 34. The inner ring 30, the outer ring 32 and/or the rolling elements 34 of the rolling element bearing 28, and preferably all of the rolling contact parts of the rolling element bearing 28 are manufactured from steel that comprises 0.20 to 0.40 weight-% carbon.

A component manufactured using a method according to an embodiment of the invention, in which heat has been supplied at least to the weld joint(s) of the component after flash butt welding, will have a smaller heat affected zone (HAZ) than a corresponding component manufactured using a conventional method in which heat is not supplied to the component after flash butt welding, but in which the component is cooled without using any thermal insulation. Such a component will therefore have improved and/or more uniform physical properties as compared with a component manufactured using said conventional method.

Further modifications of the invention within the scope of the claims will be apparent to a skilled person.

1. A method for manufacturing a steel component having a flash butt weld joint, the method comprising steps of:
flash butt welding the joint by flashing and upsetting the weld, and
supplying heat to at least the weld joint of said component after the step of upsetting the weld to increase the temperature of the weld joint, or to maintain the temperature of the weld joint at an elevated temperature.

2. The method according to claim 1, further comprising a step of cooling said component to a temperature above the martensite start temperature (Ms) before said step of supplying heat to at least the weld joint of said component and after the step of upsetting the weld to increase the temperature of the weld joint of said component.

3. The method according to claim 1, wherein said heat is supplied by heating at least said weld joint with a heating means.

4. The method according to claim 3, wherein said heating means comprises induction heating means.

5. The method according to claim 1, wherein said heat is supplied by heating at least said weld joint with flash butt welding apparatus.

6. The method according to claim 5, wherein said heat is supplied by heating at least said weld joint with flash butt welding apparatus using alternating current (AC).

7. The method according to claim 1, wherein said heat is supplied by insulating at least said weld joint after the step of upsetting the weld.

8. The method according to claim 1, further comprising a step of cooling said component only after said step of supplying heat to at least said weld joint.

9. The method according to claim 8, further comprising a step of hardening at least part of said component after said heat supplying step.

10. The method according to claim 1, wherein said steel has a carbon content of 0.1-1.1 weight-%.

11. The method according to claim 1, wherein said component is a ring.

12. The method according to claim 11, wherein said ring is a bearing ring.

13. The method according to claim 11, wherein said ring has an outer diameter equal to, or greater than 0.5 m.

14. The method according to claim 1, wherein said steel has the following composition in weight-%:
C 0.5-1.1%
Si 0-0.15%
Mn 0-1.0%
Cr 0.01-2.0%
Mo 0.01-1.0%
Ni 0.01-2.0%
at least one of V and Nb 0.01-1.0% of V or 0.01-1.0% of Nb, or 0.01-1.0% of both elements
S 0-0.002%
P 0-0.010%
Cu 0-0.15%
Al 0.010-1.0%, and
a balance of Fe and normally occurring impurities.

15. A component having a flash butt weld joint, said component is manufactured by:
flash butt welding the joint by flashing and upsetting the weld, and
supplying heat to at least the weld joint of said component after the step of upsetting the weld to increase the temperature of the weld joint, or to maintain the temperature of the weld joint at an elevated temperature.

16. The component according to claim 15, wherein said component is a ring.

17. The component according to claim 16, wherein said component is a bearing ring.
